(19) United States
(12) Patent Application Publication
(10) Pub. No.: US 2022/0285688 A1
(43) Pub. Date: Sep. 8, 2022

(54) SECONDARY CELL ELECTRODE AND METHOD FOR MANUFACTURING SAME

(71) Applicant: NIPPON ELECTRIC GLASS CO., LTD., Otsu-shi, Shiga (JP)

(72) Inventors: Kei TSUNODA, Otsu-shi (JP); Hideo YAMAUCHI, Otsu-shi (JP)

(21) Appl. No.: 17/636,628

(22) PCT Filed: Sep. 10, 2020
(86) PCT No.: PCT/JP2020/034330

§ 371 Date: Feb. 18, 2022

(30) Foreign Application Priority Data
Sep. 20, 2019 (JP) 2019-171540

(51) Int. Cl. H01M 4/62; H01M 4/04; H01M 10/0525

(52) U.S. Cl. CPC H01M 4/623; H01M 4/0471; H01M 10/0525

(57) ABSTRACT

Provided is a secondary cell electrode capable of achieving excellent charge and discharge capacities. A secondary cell electrode contains an electrode active material powder and an organic binder and emits fluorescence in Raman spectrometry with a wavelength of 532 nm.

### TECHNICAL FIELD

The present invention relates to: electrodes which are members constituting secondary cells for use in mobile electronic devices, electric vehicles, and so on; and methods for manufacturing the same.

### BACKGROUND ART

Lithium ion secondary cells have secured their place as high-capacity and light-weight power sources essential for mobile devices, electric vehicles, and so on. Current lithium ion secondary cells employ as their electrolytes, mainly, combustible organic electrolytic solutions, which raises concerns about the risk of a cell burning or the like. As a solution to this problem, developments of lithium ion all-solid-state cells using a solid electrolyte instead of an organic electrolytic solution have been promoted (see, for example, Patent Literature 1).

Furthermore, because global price increase of raw materials for lithium is also a cause of concern for lithium, sodium has attracted attention as a material to replace lithium and there is proposed a sodium ion all-solid-state cell in which NASICON-type sodium ion-conductive crystals made of Na₃Zr₂Si₂PO₁₂ are used as a solid electrolyte (see, for example, Patent Literature 2). Alternatively, beta-alumina-based solid electrolytes, including β-alumina (theoretical composition formula: Na₂O.11Al₂O₃), β-alumina (theoretical composition formula: Na₂O.5.3Al₂O₃) Li₂O-stabilized β″-alumina (Na_{1.7}Li_{0.3}Al_{10.7}O₁₇), and MgO-stabilized β″-alumina ((Al_{10.32}Mg_{0.68}O₁₆) (Na_{1.68}O)), and Na₅YSi₄O₁₂ are also known to exhibit high sodium-ion conductivity. These solid electrolytes can also be used for sodium ion all-solid-state cells.

### CITATION LIST

### Patent Literature

[PTL 1]

JP-A-H05-205741

[PTL 2]

JP-A-2010-15782

### SUMMARY OF INVENTION

### Technical Problem

An example of an electrode layer in a secondary cell is one made of a sintered body of a raw material powder containing an electrode active material powder. However, in this case, the degree of sintering of the raw material powder may be insufficient to obtain a dense sintered body, so that sufficient charge and discharge capacities may not be able to be obtained. To cope with this, there is proposed a method of binding the raw material powder with an organic binder to increase the adhesiveness between powder particles. However, the organic binder itself has poor ionic conductivity, so that desired charge and discharge capacities may not be still able to be obtained.

In view of the foregoing, the present invention has an object of providing a secondary cell electrode capable of achieving excellent charge and discharge capacities.

### Solution to Problem

The inventors conducted intensive studies and, as a result, found that the above challenge can be solved when a secondary cell electrode containing an electrode active material powder and an organic binder emits fluorescence in Raman spectrometry with a particular wavelength.

Specifically, a secondary cell electrode according to the present invention contains an electrode active material powder and an organic binder and emits fluorescence in Raman spectrometry with a wavelength of 532 nm. As will be described hereinafter, it has been found that when, in a secondary cell electrode containing an electrode active material powder and an organic binder, the organic binder is modified by partial decomposition by firing at a predetermined temperature, the secondary cell electrode emits fluorescence in Raman spectrometry with a wavelength of 532 nm. Furthermore, it has also been found that, in the above state where the organic binder is modified to cause a structural change, the secondary cell electrode has an excellent ionic conductivity of the organic binder, resulting in desired charge and discharge capacities.

A secondary cell electrode according to another aspect of the present invention is a secondary cell electrode containing an electrode active material powder and an organic binder and has a rate of mass reduction of 5% or less when thermally treated at a decomposition temperature of the organic binder plus 50° C. Generally, when a secondary cell electrode is thermally treated at the decomposition temperature of an organic binder plus 50° C., the decomposition of the organic binder progresses to generate CO₂ gas, CO gas, H₂O gas and so on, so that the mass of the secondary cell electrode largely reduces. Unlike the above, the secondary cell electrode according to the present invention has a feature that the rate of mass reduction when thermally treated at the decomposition temperature of the organic binder plus 50° C. is as small as 5% or less. This means that because the organic binder is already partly decomposed and thus modified, the secondary cell electrode is in a state where further decomposition of the organic binder progresses very little. In this case, as described above, the secondary cell electrode has an excellent ionic conductivity of the organic binder and can achieve desired charge and discharge capacities.

A secondary cell electrode according to still another aspect of the present invention is a secondary cell electrode containing an electrode active material powder and an organic binder and is free from appearance of an exothermic peak and an endothermic peak in DTA (differential thermal analysis) measurement in a range from a decomposition temperature of the organic binder to the decomposition temperature of the organic binder plus 100° C. As described previously, generally, when a secondary cell electrode is thermally treated at a higher temperature than the decomposition temperature of an organic binder, the decomposition of the organic binder progresses to generate CO₂ gas, CO gas, H₂O gas and so on. In this case, when the secondary cell electrode is subjected to DTA measurement, an exothermic peak or an endothermic peak appears. Unlike this, the secondary cell electrode according to the present invention has a feature that neither exothermic peak nor endothermic peak appears in DTA measurement in a range from the decomposition temperature of the organic binder to the decomposition temperature of the organic binder plus 100° C. This means that because the organic binder is already partly decomposed and thus modified, the secondary cell electrode is in a state where further decomposition of the organic binder progresses very little. In this case, as described above, the secondary cell electrode has an excellent ionic conductivity of the organic binder and can achieve desired charge and discharge capacities.

The secondary cell electrode according to the present invention is preferably made of a sintered body of a material containing the electrode active material powder and the organic binder.

The secondary cell electrode according to the present invention preferably contains the organic binder in an amount of 0.1 to 30% by mass.

In the secondary cell electrode according to the present invention, the organic binder is preferably at least one selected from polyacrylic acid, sodium polyacrylate, sodium methyl cellulose, polyvinylidene fluoride, styrene-butadiene rubber, polyimide, and polyethylene oxide.

In the secondary cell electrode according to the present invention, the electrode active material powder is preferably graphite, hard carbon, titanium oxide, Si, Sn or Bi.

The secondary cell electrode according to the present invention may further contain a solid electrolyte powder. Thus, an ion-conducting path can be formed in the inside of the electrode.

In the secondary cell electrode according to the present invention, the solid electrolyte powder is preferably a sodium ion-conductive crystal powder.

In the secondary cell electrode according to the present invention, the sodium ion-conductive solid electrolyte powder is preferably at least one material selected from β-alumina, β″-alumina, and NASICON crystals.

A method for manufacturing a secondary cell electrode includes the step of firing a material containing an electrode active material powder and an organic binder in a range from a decomposition temperature of the organic binder minus 50° C. to the decomposition temperature of the organic binder plus 250° C. By doing so, the organic binder is modified to cause a structural change and partly remains in the electrode without being fully burned off. In this case, the obtained electrode emits fluorescence in Raman spectrometry with a wavelength of 532 nm and, as described previously, has an excellent ionic conductivity of the organic binder and can achieve desired charge and discharge capacities.

### Advantageous Effects of Invention

The present invention enables provision of a secondary cell electrode capable of achieving excellent charge and discharge capacities.

### BRIEF DESCRIPTION OF DRAWINGS

[FIG. 1]

FIG. 1 is a graph showing initial charge and discharge curves of a test cell of No. 4 in Examples.

### DESCRIPTION OF EMBODIMENTS

A secondary cell electrode according to the present invention contains an electrode active material powder and an organic binder. Hereinafter, a description will be given of constitutional elements.

### Electrode Active Material Powder

Electrode active material powders include a positive-electrode active material powder and a negative-electrode active material powder.

Examples of the positive-electrode active material powder include active material powders for sodium ion secondary cells containing Na, M (where M represents at least one transition metal element selected from Cr, Fe, Mn, Co, and Ni), P, and O, such as NaCrO₂, Na_{0.7}MnO₂, NaFe_{0.2}Mn_{0.4}Ni_{0.4}O₂, Na₂FeP₂O₇, NaFePO₄, Na₃V₂ (PO₄)₃, Na₂CoP₂O₇, Na₂NiP₂O₇, and Na_{2/3}Ni_{2/3}Mn_{2/3}O₂. Particularly, crystals containing all of Na, M, P, and O are preferred because they have high capacity and excellent chemical stability. Preferred among them are triclinic crystals belonging to space group P1 or P-1 and particularly preferred are crystals represented by a general formula NaₓM_{y}P₂O₇ (where 1.20≤x≤2.80 and 0.95≤y≤1.60), because these crystals have excellent cycle characteristics.

Further examples of the positive-electrode active material powder include active material powders for lithium ion secondary cells, such as LiCoO₂, LiFePO₄, and LiMn₂O₄.

Examples of the negative-electrode active material powder include carbon powders, such as graphite and hard carbon, ceramic powders, such as titanium oxide (anatase form or rutile form), and metallic powders, such as Si, Sn, and Bi. Note that graphite, hard carbon, ceramic powders, Si, and so on are less likely to be softened and deformed by heat and, therefore, an organic binder is basically required to be added to these materials in order to obtain a dense sintered body. Hence, use of these electrode active material powders less likely to be softened and deformed by heat is more likely to receive the benefit of the effects of the invention.

### Organic Binder

Examples of the organic binder include polyacrylic acid, sodium polyacrylate, sodium methyl cellulose, polyvinylidene fluoride, styrene-butadiene rubber, polyimide, and polyethylene oxide. These materials may be used singly or may be used in a mixture of two or more of them.

The secondary cell electrode according to the present invention has a feature that it emits fluorescence in Raman spectrometry with a wavelength of 532 nm, which shows a state where the organic binder is modified by firing to cause a structural change (a rubbery state). In this state where the organic binder is modified to cause a structural change, the organic binder has an excellent ionic conductivity, so that the charge and discharge capacities are likely to increase.

A secondary cell electrode according to another aspect of the present invention has a feature that its rate of mass reduction when thermally treated at the decomposition temperature of the organic binder plus 50° C. is 5% or less, which also shows a state where the organic binder is modified by firing, so that further decomposition progresses very little. Also in this case, the organic binder has an excellent ionic conductivity, so that the charge and discharge capacities are likely to increase. The rate of mass reduction of the secondary cell electrode when thermally treated at the decomposition temperature of the organic binder plus 50° C. is preferably 3% or less, more preferably 1% or less, and particularly preferably 0%.

A secondary cell electrode according to still another aspect of the present invention has a feature that neither exothermic peak nor endothermic peak appears in DTA measurement in a range from the decomposition temperature of the organic binder to the decomposition temperature of the organic binder plus 100° C., which also shows a state where the organic binder is modified by firing to cause a structural change. Also in this case, the organic binder has an excellent ionic conductivity, so that the charge and discharge capacities are likely to increase.

The content of the organic binder in the secondary cell electrode according to the present invention is preferably 0.1 to 30% by mass, more preferably 0.2 to 20% by mass, still more preferably 0.3 to 10% by mass, and particularly preferably 0.5 to 5% by mass. If the content of the organic binder is too small, the binding properties between the electrode active material powder particles and between the electrode active material powder and the solid electrolyte powder cannot be achieved well and, therefore, an ion-conducting path cannot be ensured, so that the charge and discharge capacities are likely to decrease. Alternatively, in the case of an all-solid-state cell, the binding properties between the electrode and the solid electrolyte layer are less likely to be achieved, so that the electrode may peel off from the solid electrolyte layer. On the other hand, if the content of the organic binder is too large, the internal resistance of the electrode becomes high, so that the charge and discharge capacities may significantly decrease. In addition, the volume of the electrode active material in the electrode decreases, so that the energy density decreases.

### Other Components

The secondary cell electrode according to the present invention may contain, in addition to the above components, a solid electrolyte powder and/or a conductive agent.

The secondary cell electrode may contain a solid electrolyte powder in order to form an ion-conducting path in the inside of the electrode. Examples of the solid electrolyte powder include sodium ion-conductive crystal powders, such as β-alumina, β″-alumina, and NASICON crystals, and lithium ion-conductive crystal powders, such as LLZ (Ga-doped Li₇La₃Zr₂O₁₂).

When the secondary cell electrode contains a conductive agent, the conductivity in the inside of the electrode increases, so that excellent charge and discharge capacities can be obtained. In addition, the secondary cell electrode can achieve high-rate charge and discharge. Specific examples of the conductive agent include highly conductive carbon blacks, such as acetylene black and Ketjenblack, graphite, coke, and metal powders, such as Ni powder, Cu powder, and Ag powder. Among them, highly conductive carbon blacks, Ni powder or Cu powder is preferably used because they exhibit excellent conductivity even when added in very small amount.

### Method for Manufacturing Secondary Cell Electrode

The secondary cell electrode according to the present invention can be manufactured, for example, by firing a material containing an electrode active material powder and an organic binder at a predetermined temperature.

Specifically, first, the electrode active material powder and the organic binder are kneaded to form a slurry. In forming a slurry, a solvent, such as N-methylpyrrolidone or water, may be added to the above materials. As necessary, a conductive agent and/or a solid electrolyte powder are further added.

The content of the organic binder in the material (solid material) is preferably 0.1 to 50% by mass, more preferably 1 to 40% by mass, still more preferably 5 to 30% by mass, and particularly preferably 10 to 25% by mass. If the content of the organic binder is too small, the binding properties between the electrode active material powder particles and between the electrode active material powder and the solid electrolyte powder cannot be achieved well and, therefore, an ion-conducting path cannot be ensured, so that the charge and discharge capacities are likely to decrease. Alternatively, in the case of an all-solid-state cell, the binding properties between the electrode and the solid electrolyte layer are less likely to be achieved, so that the electrode may peel off from the solid electrolyte layer. On the other hand, if the content of the organic binder is too large, the internal resistance of the electrode becomes high, so that the charge and discharge capacities may significantly decrease. In addition, the volume of the electrode active material in the electrode decreases, so that the energy density decreases.

Next, the obtained slurry is formed into a film, thus obtaining a secondary cell electrode precursor. For example, in the case of an all-solid-state cell, a secondary cell electrode precursor may be formed by applying the slurry with a desired thickness onto the surface of the solid electrolyte layer.

Alternatively, the slurry may be applied onto a base material made of a PET (polyethylene terephthalate) film or so on, and dried to make a green sheet, thus obtaining a secondary cell electrode precursor. In the case of an all-solid-state cell, the obtained green sheet is laid on the surface of the solid electrolyte layer and they are pressure-bonded to form a secondary cell electrode precursor.

Still alternatively, a secondary cell electrode precursor may be formed by mixing an electrode active material powder and a powdered organic binder, and then pressing the obtained mixture into the shape of pellets. By doing so, the step of forming a slurry can be omitted, leading to a reduction in production cost.

Subsequently, the secondary cell electrode precursor is fired to obtain a secondary cell electrode. The firing temperature is in a range from the decomposition temperature of the organic binder minus 50° C. to the decomposition temperature of the organic binder plus 250° C., preferably in a range from the decomposition temperature of the organic binder minus 30° C. to the decomposition temperature of the organic binder plus 180° C., more preferably in a range from the decomposition temperature of the organic binder minus 10° C. to the decomposition temperature of the organic binder plus 160° C., still more preferably in a range from the decomposition temperature of the organic binder to the decomposition temperature of the organic binder plus 140° C., and particularly preferably in a range from the decomposition temperature of the organic binder plus 10° C. to the decomposition temperature of the organic binder plus 120° C. If the firing temperature is too low, the modification of the organic binder becomes insufficient, so that a secondary cell electrode having the desired properties as described above is less likely to be obtained. On the other hand, if the firing temperature is too high, the organic binder is fully decomposed and carbonized to lose the binding force, so that the binding properties between electrode active material particles and between the electrode layer and the solid electrolyte layer tend to decrease and, thus, the charge and discharge capacities tend to significantly decrease.

After the firing is performed as described above to obtain a secondary cell electrode, it is preferred to avoid high-temperature firing, such as, for example, firing for the purpose of sintering the electrode active material particles (specifically, firing above the decomposition temperature of the organic binder plus 250° C.). The reason for this is that if such firing is performed after the secondary cell electrode is obtained, the decomposition and carbonization of the organic binder are promoted, so that a secondary cell electrode having the desired properties is less likely to be obtained.

### EXAMPLES

Hereinafter, the present invention will be described in detail with reference to examples, but the present invention is not limited to the following examples.

Tables 1 to 4 show Examples (Nos. 3 to 6 and 9 to 23) and Comparative Examples (Nos. 1, 2, 7, and 8).

TABLE 1

| | No. 1 | No. 2 | No. 3 | No. 4 | No. 5 | No. 6 | No. 7 | No. 8 |
|---|---|---|---|---|---|---|---|---|
| Solid electrolyte layer | β″-alumina | ← | ← | ← | ← | ← | ← | ← |
| Active material (particle diameter) | hard carbon | ← | ← | ← | ← | ← | ← | ← |
| | (1.0 μm) | | | | | | | |
| Content of active material (% by mass) | 80 | ← | ← | ← | ← | ← | ← | 95 |
| Conductive agent | acetylene | ← | ← | ← | ← | ← | ← | ← |
| | black | | | | | | | |
| Content of conductive agent (% by mass) | 5 | ← | ← | ← | ← | ← | ← | ← |
| Organic binder | PAH | ← | ← | ← | ← | ← | ← | — |
| Content of organic binder(% by mass) | 15 | ← | ← | ← | ← | ← | ← | 0 |
| Content of organic binder after firing | 15 | 15 | 1.5 | 1.1 | 0.5 | 0.3 | 0 | 0 |
| (% by mass) | | | | | | | | |
| Decomposition temperature of | 298 | ← | ← | ← | ← | ← | ← | — |
| organic binder (° C.) | | | | | | | | |
| Firing temperature (° C.) | — | 150 | 300 | 350 | 400 | 500 | 600 | 350 |
| Firing time (minutes) | — | 15 | ← | ← | ← | ← | ← | ← |
| Firing atmosphere | — | in the | ← | ← | ← | ← | ← | ← |
| | | air | | | | | | |
| Emission of fluorescence | no | no | yes | yes | yes | yes | no | no |
| Rate of mass reduction (% by mass) | 13.5 | 12.8 | <0.1 | <0.1 | <0.1 | <0.1 | — | — |
| Appearance of exothermic/endothermic | yes | yes | no | no | no | no | — | — |
| peak in DTA | | | | | | | | |
| Average charge voltage (V) | 0.01 | 0.03 | 0.07 | 0.17 | 0.1 | 0.2 | not | not |
| | | | | | | | operating | operating |
| Initial charge capacity (mAh/g) | 2 | 4 | 209 | 358 | 483 | 102 | — | — |
| Initial discharge capacity (mAh/g) | 1 | 2 | 112 | 235 | 290 | 19 | — | — |

TABLE 2

| | No. 9 | No. 10 | No. 11 | No. 12 | No. 13 | No. 14 |
|---|---|---|---|---|---|---|
| Solid electrolyte layer | β″-alumina | ← | ← | ← | ← | ← |
| Active material | hard carbon | ← | ← | ← | ← | ← |
| | (1.0 μm) | | | | | |
| Content of active material (% by mass) | 80 | ← | ← | ← | ← | ← |
| Conductive agent | acetylene | ← | ← | ← | ← | ← |
| | black | | | | | |
| Content of conductive agent (% by mass) | 5 | ← | ← | ← | ← | ← |
| Organic binder | 20% CL | 100% CL | PVdF | CMC1350 | CMC2200 | PAH |
| | PAH | PAH | | | | |
| Content of organic binder(% by mass) | 15 | ← | ← | ← | ← | ← |
| Content of organic binder after firing | 1.2 | 0.7 | unmeasured | 1.1 | 2.1 | 1.3 |
| (% by mass) | | | | | | |
| Decomposition temperature of | 282 | 273 | 365 | 303 | 343 | 298 |
| organic binder (° C.) | | | | | | |
| Firing temperature (° C.) | 350 | ← | ← | ← | ← | ← |
| Firing time (minutes) | 15 | ← | ← | ← | ← | ← |
| Firing atmosphere | in the | ← | ← | ← | ← | in N₂ |
| | air | | | | | |
| Emission of fluorescence | yes | yes | yes | yes | yes | yes |
| Rate of mass reduction (% by mass) | <0.1 | <0.1 | unmeasured | <0.1 | <0.1 | <0.1 |
| Appearance of exothermic/endothermic | no | no | no | no | no | no |
| peak in DTA | | | | | | |
| Average charge voltage (V) | 0.19 | 0.13 | 0.08 | 0.11 | 0.1 | 0.15 |
| Initial charge capacity (mAh/g) | 407 | 367 | 120 | 385 | 252 | 289 |
| Initial discharge capacity (mAh/g) | 294 | 243 | 50 | 215 | 151 | 185 |

TABLE 3

| | No. 15 | No. 16 | No. 17 | No. 18 | No. 19 | No. 20 | No. 21 | No. 22 |
|---|---|---|---|---|---|---|---|---|
| Solid electrolyte layer | β″-alumina | ← | ← | ← | ← | ← | ← | LLZ |
| Active material (particle diameter) | hard carbon | Sn | Sn | Sn | Bi | Na_{2/3}Ni_{2/3}Mn_{2/3}O₂ | Na₂FeP₂O₇ | graphite |
| | (5 μm) | (0.07 μm) | (0.3 μm) | (0.5 μm) | (0.1 μm) | (0.7 μm) | (0.6 μm) | |
| Content of active material (% by mass) | 80 | ← | ← | ← | ← | ← | ← | ← |
| Conductive agent | acetylene | ← | ← | ← | ← | ← | ← | ← |
| | black | | | | | | | |
| Content of conductive agent (% by mass) | 5 | ← | ← | ← | ← | ← | ← | ← |
| Organic binder | PAH | ← | ← | ← | ← | ← | ← | ← |
| Content of organic binder(% by mass) | 15 | ← | ← | ← | ← | ← | ← | ← |
| Content of organic binder after firing | 1.1 | 1.2 | 1.1 | 1.3 | 1.2 | 1.4 | 1.2 | 1.2 |
| (% by mass) | | | | | | | | |
| Decomposition temperature of | 298 | ← | ← | ← | ← | ← | ← | ← |
| organic binder (° C.) | | | | | | | | |
| Firing temperature (° C.) | 350 | ← | ← | ← | ← | ← | ← | ← |
| Firing time (minutes) | 15 | ← | ← | ← | ← | ← | ← | ← |
| Firing atmosphere | in the | ← | ← | ← | ← | ← | ← | ← |
| | air | | | | | | | |
| Emission of fluorescence | yes | yes | yes | yes | yes | yes | yes | yes |
| Rate of mass reduction (% by mass) | <0.1 | <0.1 | <0.1 | <0.1 | <0.1 | <0.1 | <0.1 | <0.1 |
| Appearance of exothermic/endothermic | no | no | no | no | no | no | no | no |
| peak in DTA | | | | | | | | |
| Average charge voltage (V) | 0.17 | 0.08 | 0.08 | 0.09 | 0.42 | 3.17 | 2.81 | 0.12 |
| Initial charge capacity (mAh/g) | 462 | 656 | 750 | 672 | 512 | 111 | 82 | 202 |
| Initial discharge capacity (mAh/g) | 335 | 591 | 723 | 632 | 415 | 96 | 73 | 121 |

TABLE 4

| | No.23 |
|---|---|
| Solid electrolyte layer | β″-alumina |
| Active material (particle diameter) | hard carbon |
| | (1.0 μm) |
| Content of active material (% by mass) | 70 |
| Conductive agent | acetylene black |
| Content of conductive agent (% by mass) | 5 |
| Solid electrolyte powder | β″-alumina |
| Content of solid electrolyte powder (% by mass) | 10 |
| Organic binder | PAH |
| Content of organic binder(% by mass) | 15 |
| Content of organic binder after firing(% by mass) | 1.2 |
| Decomposition temperature of organic binder (° C.) | 298 |
| Firing temperature (° C.) | 350 |
| Firing time (minutes) | 15 |
| Firing atmosphere | in the air |
| Emission of fluorescence | yes |
| Rate of mass reduction (% by mass) | <0.1 |
| Appearance of exothermic/endothermic peak in DTA | no |
| Average charge voltage (V) | 0.08 |
| Initial charge capacity (mAh/g) | 349 |
| Initial discharge capacity (mAh/g) | 233 |

### Sample Nos. 1 to 8

A raw material was obtained by weighing a hard carbon powder (BELLFINE (registered trademark) LN-0001, D₅₀=1 μm, manufactured by AT Electrode) as an electrode active material powder (negative-electrode active material powder), acetylene black (SUPER C65 manufactured by TIMCAL) as a conductive agent, and polyacrylic acid (PAH, degree of cross-linkage: 0%, manufactured by Wako Pure Chemical Industries, Ltd.) as an organic binder to reach, in terms of % by mass, 80%, 5%, and 15%, respectively. N-methylpyrrolidone was added in equal amount to the raw material and the obtained mixture was stirred well with a planetary centrifugal mixer to form a slurry. All of these operations were performed in an environment of a dew point of −50° C. or below. As for No. 8, no organic binder was added and the electrode active material powder and the conductive agent were added at the rates shown in Table 1.

The obtained slurry was applied with a thickness of 100 μm to an area of 1 cm² on one of the surfaces of a 0.5-mm thick solid electrolyte layer made of β″-alumina (manufactured by Ionotec Ltd., composition formula: Na_{1.7}Li_{0.3}Al_{10.7}O₁₇) and dried at 70° C. for an hour. Thereafter, the slurry was held in the air for 15 minutes at the firing temperature shown in Table 1, thus forming an electrode (a negative electrode layer) on the one of the surfaces of the solid electrolyte layer. As for No. 1, firing was not performed.

The obtained electrode was subjected to Raman spectrometry to check for emission of fluorescence. Specifically, the central portion of the electrode was irradiated with laser light using a laser Raman microscope RAMAN touch (manufactured by Nanophoton Corporation, with a laser light source having a wavelength of 532 nm and a laser power of 1500 mW) and measured in terms of fluorescence in a wavelength range of 51 to 2630 cm⁻¹ at a laser power of 10⁶ W/cm².

Furthermore, the obtained electrode was determined in terms of rate of mass reduction when thermally treated at the decomposition temperature of the organic binder plus 50° C., wherein the rate of mass reduction can be calculated from the following formula.

Rate of mass reduction=((mass of electrode before being fired)−(mass of electrode after being fired))/(mass of electrode before being fired)×100 (%)

Moreover, the obtained electrode was subjected to DTA measurement to check for appearance of any exothermic peak and any endothermic peak in a range from the decomposition temperature of the organic binder to the decomposition temperature of the organic binder plus 100° C.

Next, a current collector of a 300-nm thick gold electrode was formed on the surface of the electrode layer using a sputtering device (SC-701AT manufactured by Sanyu Electron Co., Ltd.). Subsequently, in an argon atmosphere of a dew point of −60° C. or below, metallic sodium serving as a counter electrode was pressure-bonded to the other surface of the solid electrolyte layer and the obtained product was placed on a lower lid of a coin cell and covered with an upper lid to produce a CR2032-type test cell.

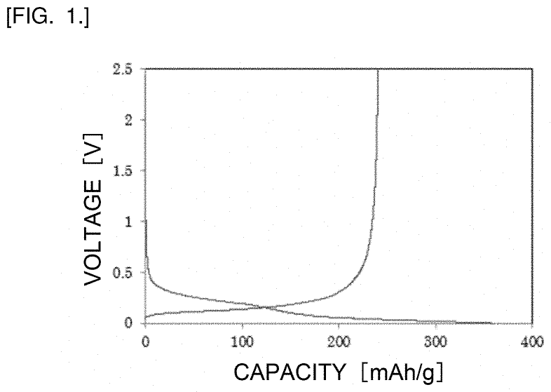

The obtained test cell underwent a charge and discharge test to determine its initial charge and discharge capacities and its average discharge voltage. The results are shown in Table 1. Furthermore, the initial charge and discharge curves of No. 4 are shown in FIG. 1. In the charge and discharge test, charging (absorption of sodium ions to the negative-electrode active material) was implemented by CC (constant-current) charging from the open circuit voltage (OCV) to 0.001 V and discharging (release of sodium ions from the negative-electrode active material) was implemented by CC discharging from 0.001 V to 2.5 V. The C rate was 0.1 C and the test was performed at 60° C. The charge and discharge capacities are defined as respective amounts of electricity charged and discharged per unit mass of the negative-electrode active material contained in the negative electrode layer.

### No. 9

A test cell was produced in the same manner as in No. 4 except that 20% cross-linked polyacrylic acid (20 CLPAH manufactured by Wako Pure Chemical Industries, Ltd.) was used as an organic binder, and underwent the charge and discharge test. The results are shown in Table 2.

### No. 10

A test cell was produced in the same manner as in No. 4 except that 100% cross-linked polyacrylic acid (100 CLPAH manufactured by Wako Pure Chemical Industries, Ltd.) was used as an organic binder and the amount of N-methylpyrrolidone added was doubled, and underwent the charge and discharge test. The results are shown in Table 2.

### No. 11

A test cell was produced in the same manner as in No. 4 except that polyvinylidene fluoride (PVdF) was used as an organic binder, and underwent the charge and discharge test. The results are shown in Table 2.

### Nos. 12 and 13

A test cell was produced in the same manner as in No. 4 except that sodium methyl cellulose (No. 1350 or No. 2200 (expressed as CMC1350 or CMC2200 in the table), Daicel Finechem, Ltd.) was used as an organic binder and pure water was used in place of N-methylpyrrolidone, and underwent the charge and discharge test. The results are shown in Table 2.

### No. 14

A test cell was produced in the same manner as in No. 4 except that the firing atmosphere was N₂ gas, and underwent the charge and discharge test. The results are shown in Table 2.

### Nos. 15 to 19

A test cell was produced in the same manner as in No. 4 except that the negative-electrode active material was as described in Table 3, and underwent the charge and discharge test. The results are shown in Table 3.

### Nos. 20 and 21

A test cell was produced in the same manner as in No. 4 except that the positive-electrode active material described in Table 3 was used as an electrode active material. The produced test cell underwent the charge and discharge test. In the charge and discharge test, charging (release of sodium ions from the positive-electrode active material) was implemented by CC (constant-current) charging from the open circuit voltage (OCV) to 4.5 V and discharging (absorption of sodium ions to the positive-electrode active material) was implemented by CC discharging from 4.5 V to 2.0 V. The C rate was 0.1 C and the test was performed at 60° C. The charge and discharge capacities are defined as respective amounts of electricity charged and discharged per unit mass of the positive-electrode active material contained in the positive electrode layer.

### No. 22

A test cell was produced in the same manner as in No. 4 except that graphite powder (MAGD manufactured by Hitachi Chemical Company, Ltd.) was used as an electrode active material (negative-electrode active material), LLZ (Ga-doped Li₇La₃Zr₂O₁₂ manufactured by Toshima Manufacturing Co., Ltd., thickness: 0.5 mm) was used as a solid electrolyte layer, and metallic lithium was used as a counter electrode, and underwent the charge and discharge test. The results are shown in Table 3.

### No. 23

A test cell was produced in the same manner as in No. 4 except that a raw material containing, in terms of % by mass, 70% hard carbon powder as a negative-electrode active material, 5% acetylene black as a conductive agent, 15% polyacrylic acid as a binder, and 10% β″-alumina as solid electrolyte powder was used, and underwent the charge and discharge test. The results are shown in Table 4.

As shown in Table 1, in Nos. 3 to 6 which are working examples, when their electrode layers were subjected to Raman spectrometry with a wavelength of 532 nm, emission of fluorescence was confirmed. When they were thermally treated at the decomposition temperature of the organic binder plus 50° C., the rate of mass reduction was less than 0.1%. When they were subjected to DTA measurement, neither exothermic peak nor endothermic peak appeared in a range from the decomposition temperature of the organic binder to the decomposition temperature of the organic binder plus 100° C. Therefore, Nos. 3 to 6 exhibited excellent properties: an average discharge voltage of 0.07 to 0.2 V, an initial charge capacity of 102 to 483 mAh/g, and an initial discharge capacity of 19 to 290 mAh/g.

Unlike the above, in Nos. 1 and 2 which are comparative examples, when their electrode layers were subjected to Raman spectrometry with a wavelength of 532 nm, no emission of fluorescence was confirmed. When they were thermally treated at the decomposition temperature of the organic binder plus 50° C., the rate of mass reduction was as large as 12.8% or more. When they were subjected to DTA measurement, an exothermic peak or an endothermic peak appeared in a range from the decomposition temperature of the organic binder to the decomposition temperature of the organic binder plus 100° C. Therefore, Nos. 1 and 2 exhibited poor properties: an average discharge voltage of 0.01 to 0.03 V, an initial charge capacity of 2 to 4 mAh/g, and an initial discharge capacity of 1 to 2 mAh/g. In No. 7, the organic binder was fully decomposed and carbonized by firing, so that no organic binder remained in the electrode. Therefore, the electrode layer peeled off from the solid electrolyte layer and the cell did not operate. In No. 8, since the electrode layer was made without use of an organic binder, the electrode layer did not have binding force to the solid electrolyte layer, so that the electrode layer peeled off from the solid electrolyte layer during drying and, thus, the cell did not operate.

As shown in Tables 2 to 4, also in Nos. 9 to 13 based on No. 4 and changed in the type of organic binder from No. 4, in No. 14 changed in firing atmosphere from No. 4, in Nos. 15 to 22 changed in the type of electrode active material (and the types of solid electrolyte layer and counter electrode), and in No. 23 in which solid electrolyte powder was further compounded into the electrode, when their electrode layers were subjected to Raman spectrometry with a wavelength of 532 nm, emission of fluorescence was confirmed. When they were thermally treated at the decomposition temperature of the organic binder plus 50° C., the rate of mass reduction was less than 0.1%. When they were subjected to DTA measurement, neither exothermic peak nor endothermic peak appeared in a range from the decomposition temperature of the organic binder to the decomposition temperature of the organic binder plus 100° C. As for No. 11, however, the electrode layer was not subjected to part of these measurements. Hence, these samples exhibited excellent properties: an average discharge voltage of 0.08 to 3.17 V, an initial charge capacity of 82 to 750 mAh/g, and an initial discharge capacity of 50 to 723 mAh/g.

1. A secondary cell electrode containing an electrode active material powder and an organic binder and emitting fluorescence in Raman spectrometry with a wavelength of 532 nm.

2. A secondary cell electrode containing an electrode active material powder and an organic binder and having a rate of mass reduction of 5% or less when thermally treated at a decomposition temperature of the organic binder plus 50° C.

3. A secondary cell electrode containing an electrode active material powder and an organic binder and free from appearance of an exothermic peak and an endothermic peak in DTA measurement in a range from a decomposition temperature of the organic binder to the decomposition temperature of the organic binder plus 100° C.

4. The secondary cell electrode according to claim 1, being made of a sintered body of a material containing the electrode active material powder and the organic binder.

5. The secondary cell electrode according to claim 1, containing the organic binder in an amount of 0.1 to 30% by mass.

6. The secondary cell electrode according to claim 1, wherein the organic binder is at least one selected from polyacrylic acid, sodium polyacrylate, sodium methyl cellulose, polyvinylidene fluoride, styrene-butadiene rubber, polyimide, and polyethylene oxide.

7. The secondary cell electrode according to claim 1, wherein the electrode active material powder is graphite, hard carbon, titanium oxide, Si, Sn or Bi.

8. The secondary cell electrode according to claim 1, further containing a solid electrolyte powder.

9. The secondary cell electrode according to claim 8, wherein the solid electrolyte powder is a sodium ion-conductive crystal powder.

10. The secondary cell electrode according to claim 9, wherein the sodium ion-conductive solid electrolyte powder is at least one material selected from β-alumina, β″-alumina, and NASICON crystals.

11. A method for manufacturing a secondary cell electrode comprising the step of firing a material containing an electrode active material powder and an organic binder in a range from a decomposition temperature of the organic binder minus 50° C. to the decomposition temperature of the organic binder plus 250° C.
